(19) United States
(12) Patent Application Publication
(10) Pub. No.: US 2009/0206011 A1
(43) Pub. Date: Aug. 20, 2009

(54) Vibrating Screen Apparatus

(76) Inventor: George F. Cudahy, Anthony, NM (US)

Correspondence Address: Ted D. Lee;Gunn & Lee, P.C., Suite 1500, 700 N. St. Mary's Street, San Antonio, TX, 78205, US

(21) Appl. No.: 12/034,511

(22) Filed: Feb. 20, 2008

(51) Int. Cl. B07B 1/42

(52) U.S. Cl. 209/365.3

(57) ABSTRACT

A vibrating screen apparatus for sizing materials is shown that has a minimum of moving parts therein. A vibrating motor is mounted below longitudinal vibrating rails. The vibrating rails rest on top of shoes attached to air mounts, which air mounts are between the vibrating rails and cross braces connected to the frame. The shoes are located inside of angled clips and attached on the underside of the vibrating rails. The angled clips hold the vibrating rails in position. The vibrating rails press against the underside of a vibrating screen to form a crown therein when the air mounts are inflated. The vibrating screen is stretched between the sides of the frame by tensioning rails. Multiple size materials can be produced by stacking multiple vibrating screen apparatuses. Access is provided to lower vibrating screens by pivoting upper vibrating screens out of the way.

This is an improvement patent application over U.S. Pat. No. 6,575,304 having the same inventor.

### BACKGROUND OF THE INVENTION

1. Field of The Invention

This invention relates to a vibrating screen mechanism and, more particularly, to a vibrating screen mechanism that is used to separate materials by size.

2. Background of the Invention

For many years, vibrating screens have been used to separate products into different sizes. While some screens may be used in an environment that is relatively mild, other screens would be used in the harshest of environments, such as mines, quarries or plants, where materials, such a bauxite, gravel, crushed rock, limestone, cement, shale or clay, are sized into different sizes. In these harsh environments in which a vibrating screen operates, any mechanically moving parts can be fouled by dust, grit or grime from the materials being sized. The larger number of moving parts to operate the vibrating screen, the greater the probability there will be a mechanical failure. The simpler the operation of the vibrating screen, the less likely the mechanical parts will foul or break.

U.S. Pat. No. 4,444,656 to Nelson shows a vibrating screen with a plurality of transverse beams extending from side to side for vibrating the screen. A large number of beams are used, as well as a large number of moving parts. Likewise, a plurality of different motors are used, with each transverse beam having a different motor and a different rate of vibration.

Typical of the modern day vibrating screen are those screens disclosed in U.S. Pat. Nos. 3,378,142; 3,834,534; 4,180,458; 4,274,953; 4,340,469; 4,632,751; 5,100,539; 5,341,939; and 5,749,471. Unlike the present invention, in each of the referenced patents, a motor is attached to a frame to which is attached a screen. Activation of the motor causes the frame and consequently, the screen to vibrate. To allow such vibration, the frame is somehow affixed to isolating devices, usually springs. U.S. Pat. No. 3,378,142 imparts the vibrating force to the frame using “two drivingly coupled resiliently borne oscillating frames having alternative inter-engaging cross members.” U.S. Pat. No. 3,834,534 attaches a screen to a frame using springs and then allows the vibration mode of the screen and frame assembly to be controlled as well as slid beneath the screen. U.S. Pat. No. 4,180,458 uses a traditional structure, but isolates the structure to achieve better noise control. U.S. Pat. No. 4,274,953 mounts the vibration motor on the outside of the frame. U.S. Pat. No. 4,340,469 imparts the vibrational force to the frame and screen using unbalanced weights to generate gyrational vibratory motion. U.S. Pat. Nos. 4,632,751; 5,100,539; 5,341,939; and 5,749471 each contain disclosures typical of vibrating frame/screens. Unlike the present invention, all of the inventions disclosed in the foregoing patents contain complex vibrating mechanisms with multiple mechanical parts and the vibrating force is imparted to a frame which in turn causes the screen to vibrate.

Not known to be the subject of a U.S. patent, is the vibrating screen apparatus utilized by J&H Equipment, Inc. (“J&H”), P.O. Box 928, Roswell, Ga. 30077, telephone number (800) 989-1606. Unlike the present invention which does not attach the vibrating screen apparatus to the screen and which does not require attachment through the screen, the J&H vibrating screen apparatus attaches rods across and through a screen. The rods are then attached to an overhead motor which, when activated, unlike the present invention, causes the entire apparatus, screen rods and screen to vibrate.

To simplify and advance the prior art, a vibrating screen apparatus must, as does the present invention, reduce the number and complexity of the mechanical parts necessary to cause vibration of the screen and which in fact vibrate. Furthermore, for ease of maintenance, the entire vibrating apparatus should be easily removed from the screen system.

U.S. Pat. No. 6,575,304 to Cudahy over which this invention is an improvement has some problems that were discovered by extended periods of use. The major problem is the vibrating rails would break due to metal fatigue where the vibrating rails are connected to the air mounts. Due to the continual vibration of the vibrating rails, over time due to metal fatigue the vibrating rails would fail adjacent to screw holes where attached to the air mounts by bolts through the screw holes.

Also, when the vibrating screens are stacked to produce materials of different size, many times it is necessary to work on intermediate vibrating screen bodies. If the upper vibrating screen bodies are physically attached, they have to be unattached and removed, or partially disassembled, before work can be performed on the lower or intermediate vibrating screen bodies.

### SUMMARY OF THE INVENTION

It is an object of the present invention to provide a vibrating screen apparatus with a minimum amount of moving parts.

It is a further object of the present invention to provide a vibrating screen apparatus that is easily maintained and repaired.

It is yet another object of the present invention to provide a vibrating screen apparatus that is more reliable and economical to operate.

It is an even further object of the present invention to provide a vibrating screen apparatus that has less dust pollution or noise proliferation.

It is yet another object of the present invention to have vibrating bars that run lengthwise of the screen to impart the necessary vibrations to the screen.

It is yet another object of the present invention to suspend the vibrating bars and pull the screen taut by inflating air mounts below the vibrating bars.

It is yet another object of the present invention to provide tension rails for proper tensioning of the wire cloth that makes up the vibrating screen.

It is even another object of the present invention to mount the vibrating motor to the vibrating bars to cause the vibration of the wire cloth of the vibrating screen apparatus.

It is another object of the present invention to provide an alternative vibrating rail that will not break due to metal fatigue caused by continuous vibration. The alternative vibrating rail is made from a unitary construction that simply rests on top of the air mounts, but is not attached to the air mounts.

It is still another object of the present invention to provide for pivotal connections for the upper and intermediate vibrating screen bodies to allow access to lower vibrating screen bodies.

In the present invention, side plates are held into position by cross braces to form the frame of the present vibrating screen apparatus. The bottom of the frame is enclosed by a bottom chute and a discharge outlet for the fine material that has gone through the last screen.

The screen is made of wire cloth that is tightened by tension rails on each side. The tension rails connect into hooks that are attached to the wire cloth and pulled tight between the respective sides of the frame.

Immediately below the screen are vibrating bars that run lengthwise of the screen. Attached to the underside of the vibrating bars is a vibrating motor that will cause the bars to vibrate. On top of the vibrating bars may be some type of resilient material, such as rubber, to keep the vibrating bars from wearing out the screen.

The vibrating bars are mounted on air mounts set on cross braces between the sides of the frame. By inflating the air mounts, the screen is tightened to the predetermined tautness that is desired when the vibrating bar is lifted. Tension on the wire cloth is increased and the vibrating mechanism is ready to be turned ON for operation.

Material to be sized comes in at the feed end of the vibrating screen apparatus. Material that is less than the predetermined size of the wire cloth will go through the screen. The remainder of the material that is larger than the predetermined size will come out of the discharge end of the vibrating screen apparatus.

If material is to be sized between a predetermined range, vibrating screen apparatuses can be stacked one on top of the other and material that comes out of the discharge end of other than the top vibrating screen apparatus would be of a predetermined size range depending upon the size of the individual screens therebetween.

To prevent air pollution by dust and other particles, a cover will cover the uppermost of the vibrating screen apparatuses. In the present invention, a rubber dust cover is used that is ratcheted down tightly into place to prevent noise proliferation or environmental pollution by dust.

Since the entire vibrating screen apparatus is gravity fed, the angle of the frame should be at least greater than the angle of repose of the material being sized. It is anticipated the angle of repose would typically be between 15-45.

In an alternative embodiment, the vibrating rails are not physically attached to the air mounts. Instead, in the alternative embodiment, the two vibrating rails are connected together as one piece with holes in between the two vibrating rails for the material being screened to drop through. Rather than being attached to the air mounts, the vibrating rails simply rest on top of the air mounts. A shoe mounted on top of the air mount is located in a pocket formed by angled clips on the underside of a V-shaped configuration of the vibrating rail. In this manner, there is not a physical connection between the vibrating rails and the air mounts and, hence, metal fatigue cased by stress concentration at the holes for the air mounts are eliminated in the current embodiment. The cracking or breaking of the vibrating screen rail is essentially eliminated.

Also, in an alternative embodiment, if more than one vibrating screen is contained in separate vibrating screen bodies and the vibrating screen bodies are stacked, the upper and intermediate screen bodies will pivot out of the way allowing access to lower vibrating screens or vibrating screen bodies. This allows for ease of maintenance to avoid the necessity of disassembly when providing routine maintenance.

### BRIEF DESCRIPTION OF THE DRAWINGS

FIG. 1 is a perspective view of a demonstration model of the present invention with a portion cut away for illustration purposes.

FIG. 2 is a partial perspective cutaway view of the present invention illustrating the mounting of the vibrating bar.

FIG. 3 is a perspective view of the frame with the vibrating bar as mounted therein.

FIG. 3A is a cross-sectional view of the vibrating mechanism of FIG. 2 along section lines 3A-3A, with the air mounts deflated.

FIG. 3B is a cross-sectional view of the vibrating mechanism of FIG. 2 along section lines 3A-3A, with the air mounts inflated.

FIG. 4 is a side view illustrating the mounting of the motor to the vibrating bar.

FIG. 5 is an enlarged partial sectional view illustrating positioning of the air mounts between the vibrating bar and the cross braces.

FIG. 6 is an enlarged partial sectional view illustrating the tensioning of the wire cloth.

FIG. 7 is an enlarged partial sectional view illustrating contact between the vibrating bar and the wire cloth.

FIG. 8 is a partial sectional view illustrating the tensioning of the wire cloth and the securing of the shroud.

FIG. 9 is a side view illustrating the stacking of multiple vibrating screens to give multiple size materials therefrom.

FIG. 10 is a top perspective view of the vibrating rails.

FIG. 11 is a bottom perspective view of an alternative embodiment of the vibrating rails.

FIG. 12 is a perspective view of the frame with the alternative vibrating rail from FIGS. 10 and 11 mounted thereon.

FIG. 13 is a cross-sectional view of FIG. 12 taken along section lines 13-13.

FIG. 14 is a partial sectional view of FIG. 13 taken along section lines 14-14.

FIG. 15 is a side view illustrating the stacking of multiple vibrating screens to give multiple size materials therefrom, which multiple vibrating screens are pivotally connected on one end thereof.

FIG. 16 is a side view of stacked multiple vibrating screens with the top vibrating screen being pivoted upward to allow access to the lower vibrating screens.

### DESCRIPTION OF THE PREFERRED EMBODIMENT

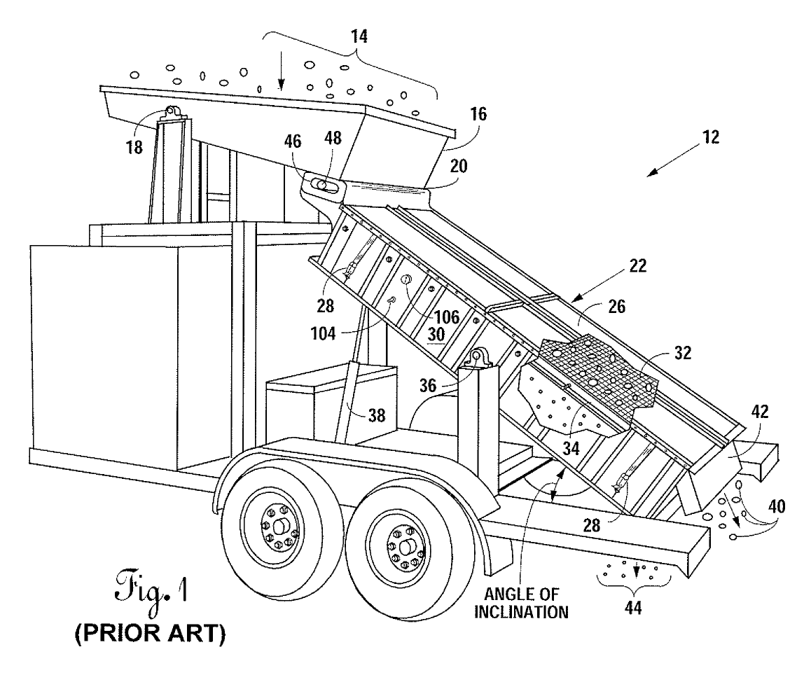

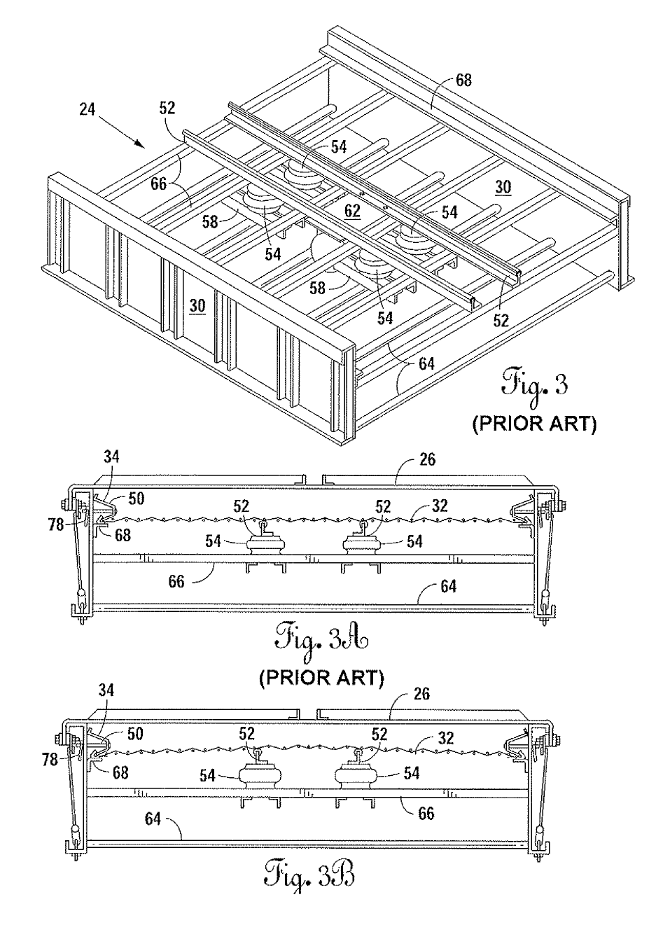

Referring to FIG. 1 of the present invention, a description of a demonstrator model of the vibrating screen apparatus 12 is shown. Material to be sized 14 feeds into the hopper 16 of the present invention. The hopper 16 may be pivoted on pivot point 18 so that the material to be sized 14 feeds out of the hopper 16 at the lower end 20 thereof into the vibrating screen body 22. The vibrating screen body 22 has a frame 24 (shown in detail in FIG. 3) that is covered by a shroud 26. The shroud 26 is held in position by ratcheted tie-downs 28 on the side walls 30.

Inside of the vibrating screen body 22 is located a vibrating screen 32 that is typically made from a wire cloth. The vibrating screen 32 is tensioned between the respective side walls 30 by means of a tension rail 34.

The angle of repose of the vibrating screen body 22 is great enough so the material be sized 14 will flow there along by gravity. The vibrating screen body 22 may be pivoted on pivot point 36 by means of hydraulic ram 38. By extending the hydraulic ram 38, the angle of repose can be increased. The slot 46 along with the pivot bar 48 allow for adjustment of the angle of repose between the hopper 16 and the vibrating screen body 22. As the material to be sized 14 feeds through the vibrating screen body 22, the larger particles 40 that will not go through the vibrating screen 32 and come out the discharge end 42. The sized particles 44 that are smaller than the spaces in the vibrating screen 32 come out of the bottom of the vibrating screen body 22.

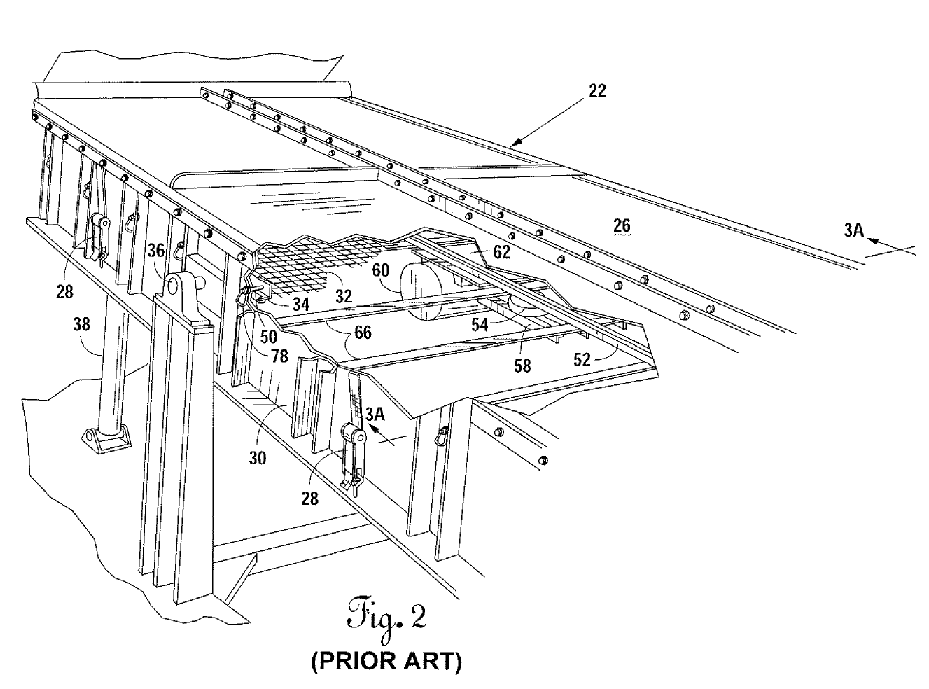

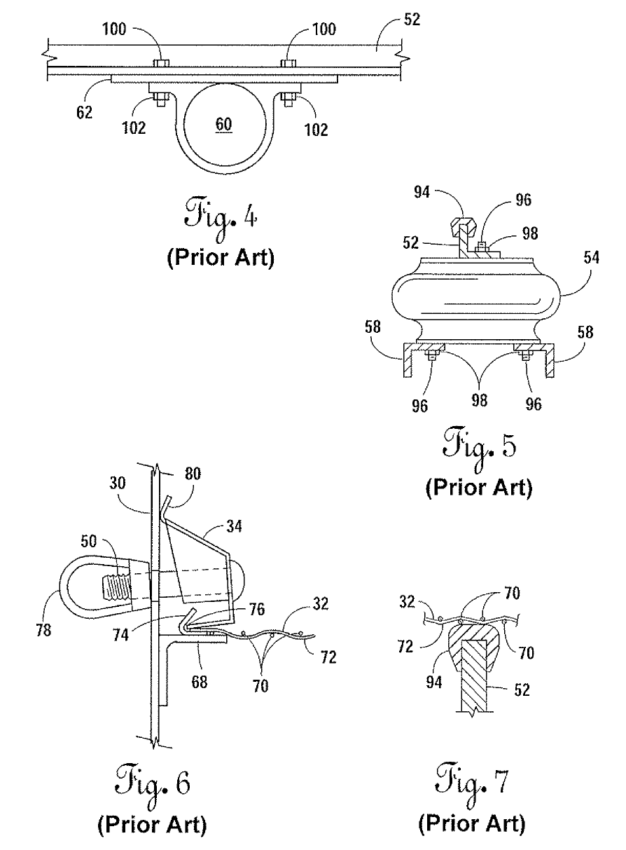

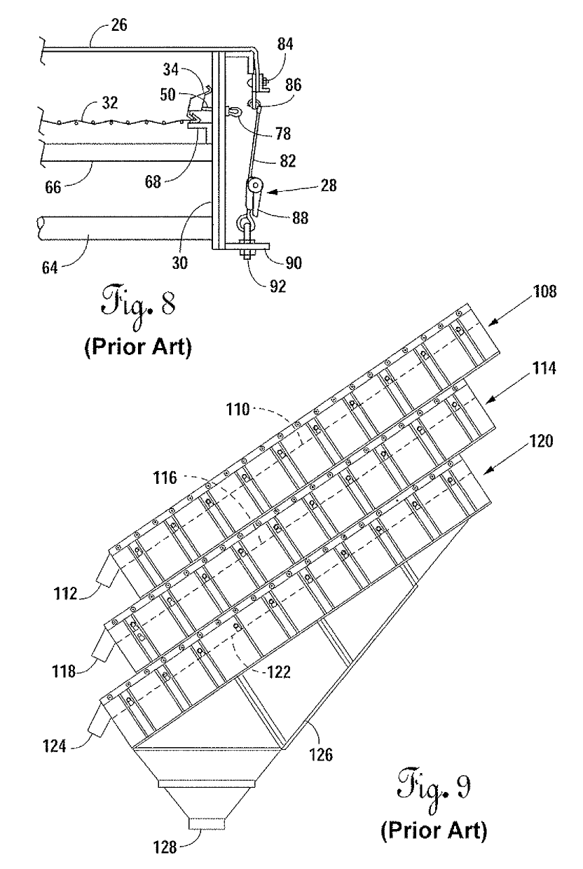

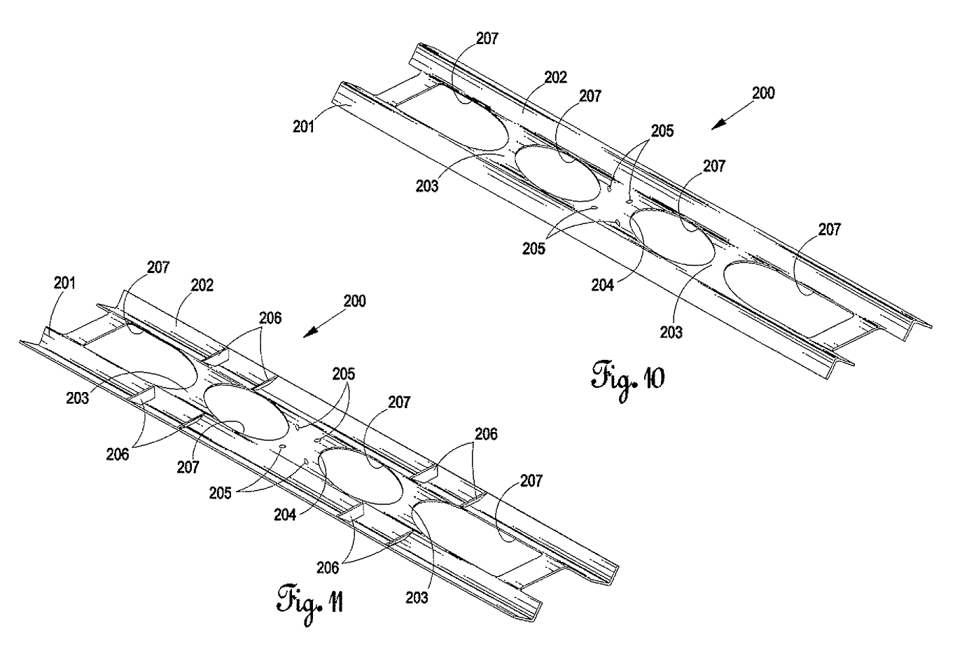

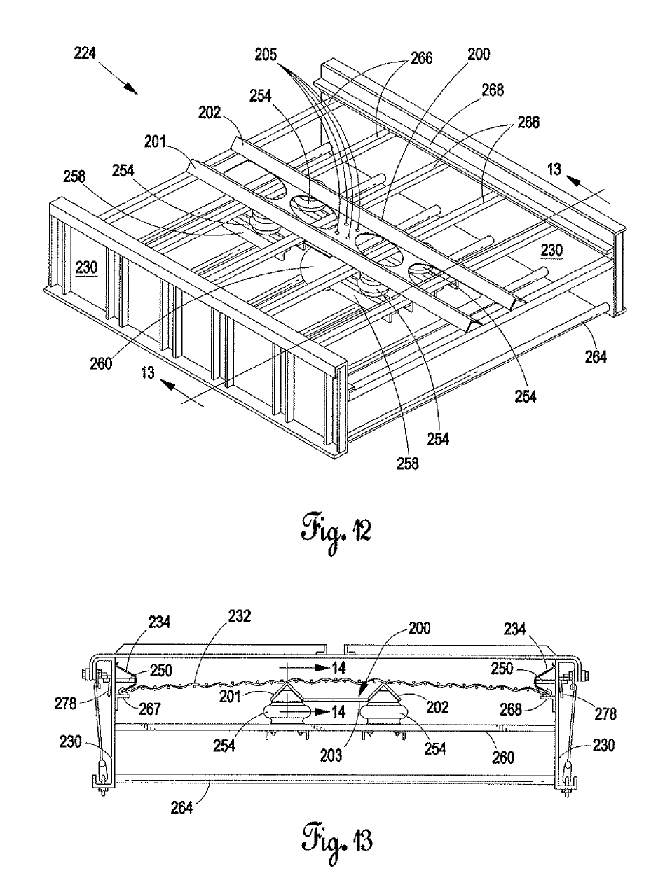

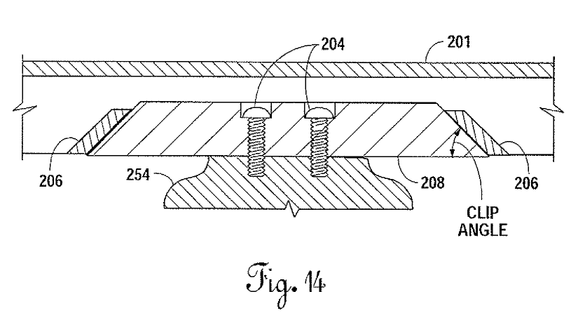

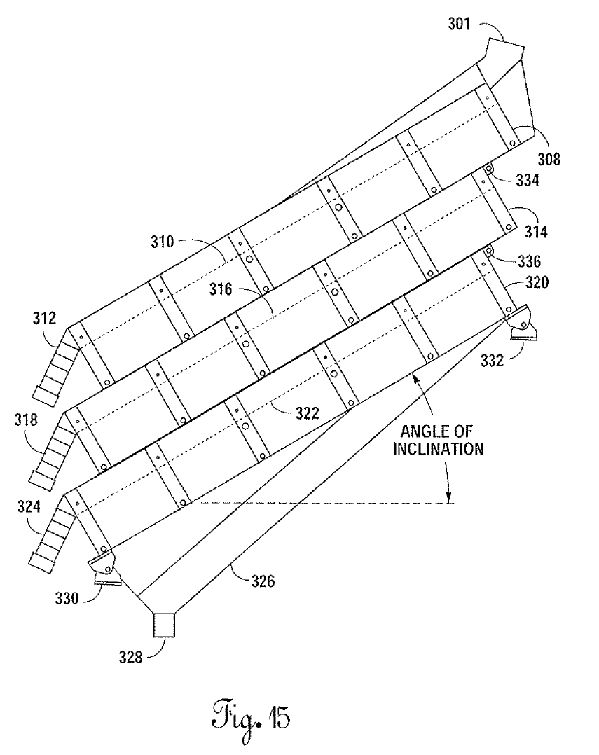

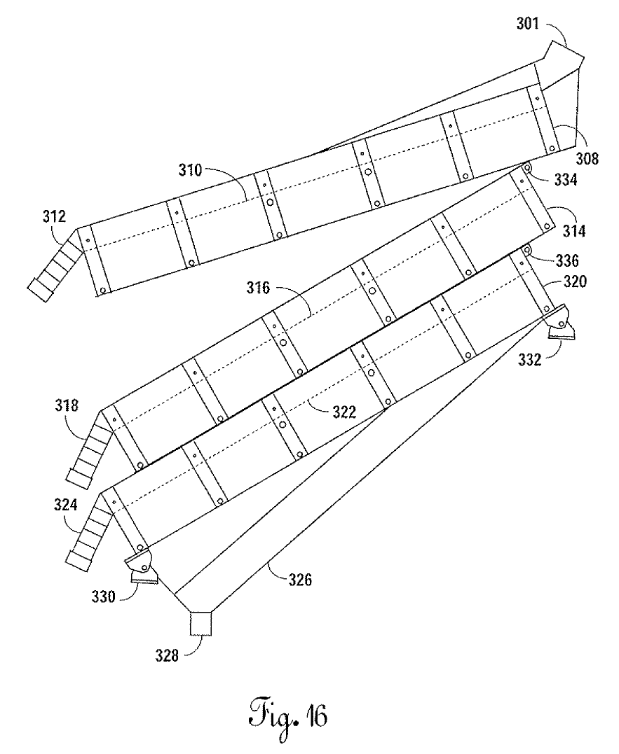

Referring now to FIG. 2 of the drawings, an enlarged partial sectional view of the vibrating screen body 22 is shown. A portion of the shroud 26 has been cut away to illustrate the screen 32 being stretched between the sides 30 by means of tension rail 34 being tightened into position by bolts 50. This will be explained in more detail in conjunction with FIG. 6.

Immediately below the vibrating screen 32, which is made of wire cloth, is located two parallel vibrating rails 52. The vibrating rails 52 run lengthwise along the vibrating screen body 22 from one end thereof to the other. The vibrating rails 52 are supported on the bottom thereof by air mounts 54. The air mounts 54 are mounted to cross braces 66 by means of a mounting platform 58.

Suspended below vibrating rails 52 is a vibrating motor 60. Vibrating motor 60 attaches directly to vibrating rails 52 by any convenient means, such as base 62. By turning on the vibrating motor 60, through the base 62, it causes the vibrating rails 52 to vibrate. The vibration of the vibrating rails 52 will in turn cause the screen 32 to vibrate. By inflating the air mounts 54, the vibrating rails 52 will be the sole contact between the screen 32, other than the edges that are tightened into place by tension rail 34.

Turning now to FIG. 3 of the drawings, the frame 24 will be explained in more detail. The side walls 30 make up the sides of the frame 24. Across the bottom of the frame 24 are lower cross braces 64, which can be of any dimension; however, applicant has found that circular braces do not cause an accumulation of the material being sized.

Towards the upper part of the side walls 30 are the upper cross braces 66. While the upper cross braces 66 can be of any particular size, square bar stock has found to be particularly suitable for this particular application. The upper cross braces 66 connect to the side walls 30 just below the vibrating screen mount 68. The vibrating rails 52 are secured to the top of the air mounts 54. The air mounts 54 are secured to the frame 24 by means of mounting platform 58 on upper cross braces 66. The vibrating motor 60 suspends below the vibrating rails 52 by means of inverted base 62.

Referring now to FIG. 3A and 3B in combination, the proper tensioning of the vibrating screen 32 is shown and explained. Referring first to the tightening of the vibrating screen 32, enlarged FIG. 6 may be useful. The vibrating screen 32 is a wire cloth that is made with a predetermined mesh. The wire cloth has warp wires 70 that run lengthwise along the vibrating screen and shoot wires 72 that run perpendicular to the warp wire and perpendicular to the side walls 30. For the purpose of tensioning vibrating screen 32, some type of hook or connection is provided on the chute wires 72. In the present case, hooks 74 are contained on the ends of the chute wires 72. To install the vibrating screen 32, it is placed inside of the vibrating screen body 22 on the vibrating screen mount 68. Then the hook side 76 of the tension rail 34 is placed inside of the hooks 74. By tightening nuts 78 on bolts 50, the slide side 80 of the tension rail 34 will slide along the side 30 and allow the tension rail 34 to tighten screen 32 by pulling against the hooks 74. By tightening the nuts 78 on the bolts 50, the vibrating screen 32 can be tightened to any desired tension. However, care should be exercised not to tighten too much, otherwise any bend contained in the warp wires or chute wires of the vibrating screen 32 may be deformed.

Again, referring to FIGS. 3A and 38, the tightening of the shroud 26 will be explained in conjunction with enlarged cross-sectional view FIG. 8. The ratcheted tie-downs 28 will be explained in more detail. A strap 82 is connected to the shroud 26 by any convenient means, such as bolts 84 having eyelets with hooks 86 running therethrough. The hooks 86 connect to strap 82, which are tightened by ratchet 88. The other side of the ratchet 88 is connected to side wall 30 by means of flange 90 and bolt 92.

In FIG. 3A, the air mounts 54 are deflated and the vibrating screen 32 is in its lowermost position. However, in FIG. 3B, the air mounts 54 are inflated so the vibrating rails 52 are raised up. In that manner, the vibrating screen 32 forms a crown and only comes into contact with the vibrating rails 52. Therefore, when the vibrating rails 52 vibrate, the screen 32 will vibrate.

Referring to FIG. 7, the top part of the vibrating rail 52 is shown. The uppermost portion of vibrating rail 52 is capped by a rubber grommet 94 to prevent damage to the vibrating screen 32. Any other type of resilient material to prevent damage to vibrating screen 32 can be used. In situations where a hot material is being sized, the rubber grommet 94 can be replaced with a heat resistant flexible material or even eliminated, if necessary.

Referring now to FIG. 5, the mounting of the vibrating rail 52 to the air mount 54 is illustrated. The vibrating rail 52 may be connected to air mount 54 by any convenient means, such as bolt 96 and nut 98. On the underside, the air mount 54 is connected to the mounting platform 58 by means of similar bolt 96 and nut 98. Also, the rubber grommet 94 is illustrated on the vibrating rail 52.

“FIG. 4 shows the mounting of the vibrating motor 60 on the underside of the vibrating rails 52 by means of bolts 100 and nuts 102 through base 62. The vibrating motor may be of any particular type, but those vibrating motors which have adjustable weights in order to adjust the vibrating force, and which have the ability to be powered by variable frequency drives in order to select the most desireable motor RPM, are particularly suitable for this application. The size of the screen and the particular application also dictates the motor horse power required.”

In actual operation, the vibrating screen apparatus can be tightened to a particular tension by inflating the air mounts 54 through inflating valve 104 as shown in FIG. 1. The inflating valve is connected by hoses (not shown) to the air mounts 54. The pressure gauge 106 measures the amount of pressure that has been inserted in air mounts 54. By use of the air mounts 54 and inflating them to a predetermined pressure, the tension on the vibrating screen 32 is continually adjusted. This adjustment eliminates the re-tensioning of the screen 32 or makes the re-tensioning a less frequent requirement.

By putting the material to be sized 14 into hopper 16 and allowing it to flow through the lower end 20 thereof into the vibrating screen body 22, material to be sized 14 now flows along the vibrating screen body 22. Particles that were too large to flow through the vibrating screen 32 will come out the discharge end 42 as larger particles 40. The sized particles 44 will flow out of the bottom of the vibrating screen body 22. To size particles over a range, the vibrating screen bodies 22 may be stacked in a manner as shown in FIG. 9. The material to be sized 14 would then flow into the upper vibrating screen body 108. The particles that were too large to flow through the upper vibrating screen 110 will then come out of discharge end 112. However, the materials that flow through the upper vibrating screen 110 into the intermediate vibrating screen body 114 will then be vibrated along intermediate vibrating screen 116. Hence, particles that would flow through upper vibrating screen 110, but not intermediate vibrating screen 116, would come out intermediate discharge 118. Therefore, the particles coming out of intermediate discharge 118 are of a predetermined size range. For further refinement, a lower vibrating screen body 120 with a lower vibrating screen 122 is also included. From the lower discharge 124, even finer size particles are discharged that would flow through upper vibrating screen 100, intermediate vibrating screen 116, but not lower vibrating screen 122.

In the stacking of vibrating screen bodies as illustrated in FIG. 9, the coarser vibrating screens are at the top and the finer vibrating screens are at the bottom. From the lower vibrating screen body 120 is located a bottom chute 126, with a bottom funnel 128. Only the finest of particles would come out of bottom funnel 128, which particles would flow through each of the upper vibrating screen 110, intermediate vibrating screen 116, and lower vibrating screen 122. In this manner, a different range of sized particles can be determined in any given condition. Any number of vibrating screens can be stacked for many different sized particles.

Much of the description of the preferred embodiment is prior art as contained in U.S. Pat. No. 6,575,304 which is hereby incorporated by reference. The same numbers as utilized in the incorporated reference will be used hereinbelow with the number 200 added thereto. Therefore, for the improved versions as will be shown and described in conjunction with FIGS. 10-16, numbering will start with the number 200 for the vibrating screen rails.

Referring to FIGS. 11 and 12 in combination, the vibrating screen rails 200 have a left side 201 and a right side 202 with cross members 203 extending therebetween. In the center cross member 204 is located with holes 205 therein through which the vibrating motor 260 (see FIG. 12) is attached. Opposing clips 206 are welded on the underside portion of the V-shaped left side 201 and right side 202 of the vibrating rails 200. The angle of the opposing clips 206 will be described in further detail hereinbelow. Openings 207 are contained between the vibrating screen rails 200 to allow material being screened to drop therethrough.

Referring to FIG. 12, a frame 224 for a vibrating screen body is shown that has the improved unitary constructed vibrating screen rails 200 mounted thereon. The left side 201 and right side 202 of the vibrating screen rails 200 are shaped like an upside down V. A vibrating motor 260 is attached to the underside of the vibrating screen rails 200 through the previously described holes 205 (see FIGS. 10 and 11). Basically the frame 224 as shown in FIG. 12 is the same as frame 24 shown in FIG. 3 except for the vibrating screen rails 200 with left side 201 and right side 202 has been modified. The vibrating screen rails 200 are supported by air mounts 254 located on upper cross braces 266, which holds mounting platform 258. To ensure that the side walls 230 are maintained straight, lower cross braces 264 are also included.

Referring to FIGS. 12 and 13 in combination, the vibrating screen mount 268 is used to properly tension the vibrating screen 232. The tension rail 234 is tightened by bolts 250 by tightening nuts 278 in the same manner as described in conjunction with FIGS. 3A and 3B.

Referring to the partial cross sectional view shown in FIG. 14 taken along section lines 14-14 of FIG. 13, the relationship of the vibrating screen rails 200 with respect to the air mounts 254 is illustrated. The left side 201 of the vibrating screen rail 200 has opposing clips 206 welded into position as shown. The angle at which the opposing clips 206 are welded in position is equal to, or greater than, the angle of repose of the vibrating screen body which can be anywhere between 15 and 45 degrees. The opposing clips 206 are physically welded into the upside down V shaped portion of the left side 201 and right side 202 of the vibrating screen rails 200. Inside of the opposing clips 206 is a mounting shoe 208 of the air mounts 254. The mounting shoe 208 is physically attached to the air mounts 254 by recessed bolts 209. However, the mounting shoe 208 is not physically attached to the left side 201 of the vibrating screen rails 200. The mounting shoe 208 simply rests between the opposing clips 206 the mounting shoe 208 is a hard material such as hard rubber, plates or metal.

The opposing clips 206 are at an angle equal to, or greater than, the angle of inclination i.e. the angle at which the vibrating screen 232 may be raised into the air. Typically, the angle of inclination is between 15 and 45 degrees from the horizon. Therefore, if the angle of the opposing clips 206 is 45 degrees or greater measured from the longitudinal axis of the vibrating rails 200, it will take care of any screen incline angle between 15 and 45 degrees. The angles of the opposing clips 206 do not necessarily need to be the same

The mounting shoe 208 is a hard material such as a hard rubber or plastic. By simple having the vibrating screen rails 200 rest against mounting shoes 208, there is not a tendency for the vibrating screen rails 200 to break at the point of attachment to the mounting shoes 254 because there are no holes in the vibrating screen rails 200 and there is no physical attachment in an abutting relationship. Therefore, the problem of fatigue, cracks or breakage between a point of attachment of the vibrating rails and the air mounts 254 has been eliminated.

In this alternative embodiment, the material may be screened into various sizes by the use of multiple stacked vibrating screen bodies 308, 314 and 320 as shown in FIG. 15. The material to be screened is loaded through inlet 301 onto the coarse vibrating screen 310 of the upper vibrating screen body 308. Particles that are too large to pass through the coarse vibrating screen 310 will come out the discharge end 312.

For particles that drop through the coarse vibrating screen 310, they will fall onto the intermediate vibrating screen 316 of the intermediate vibrating screen body 314. Particles that are too large to pass through intermediate vibrating screen 316, but have passed through upper vibrating screen 310, will be discharged out intermediate discharge end 318.

For particles that fall through intermediate vibrating screen 316, they will fall onto fine vibrating screen 322 of fine vibrating screen body 320. For particles that will not pass through the lower vibrating screen 322, they will be discharged out lower discharge end 324. The finest particles that pass through coarse vibrating screen 310, intermediate vibrating screen 316, and fine vibrating screen 322 will be collected by bottom chute 326 and discharged out bottom funnel 328.

The angle of inclination is determined by the angle between lower mount 330 and upper mount 332 with respect to the horizon. The angle of inclination can be increased or decreased by increasing or decreasing that angle, respectively.

Many times it is necessary to work on either the vibrating screen or the vibrating screen body. If work needs to be done on the intermediate vibrating screen body 314 or the lower vibrating screen body 320, it will be problem if each of the vibrating screen bodies are bolted together. To eliminate that problem, a hinge 334 is located between the upper vibrating screen body 308 and the intermediate vibrating screen body 314. A second hinge 336 is located between the intermediate vibrating screen body 314 and the lower vibrating screen body 320. In this manner, the upper vibrating screen body 308 may be pivoted upward to allow access to the intermediate screen body 314 as is illustrated in FIG. 16. Likewise, the intermediate screen body 314 can be pivoted upward to allow access to the lower screen body 320. While the pivoting arrangement shown in FIGS. 15 and 16 is connected on one end, the pivot could be on the side versus on the end. In that manner, the upper screen body 308 or intermediate screen body 314 could be pivoted on the side versus on the end.

I claim:

1. A vibrating screen apparatus operated from a power source for separating material by size, said vibrating screen apparatus including a frame at incline angle, a vibrating screen stretched within said frame by a tensioning device, isolators mounted on cross braces of said frame to allow vibrations, but to help prevent noise and damage from such vibrations, the improvement comprising:
shoes mounted on top of said isolators;
unitary constructed vibrating rails resting on said shoes, but pressing against an underside of said vibrating screen, said unitary constructed vibrating rails having opposing clips for receiving thereunder, but not attaching to, said shoes;
upon pressuring said isolators said unitary constructed vibrating rails are raised to from a crown in said vibrating screen and increase tension thereon so that when a vibrating motor attached to said unitary constructed rails is activated, said material is separated into different sizes by vibrations of said vibrating motor via said unitary constructed rails.

2. The vibrating screen apparatus as given in claim 1 wherein said incline angel is less than a an angle of said opposing clips with respect to a longitudinal axis of said unitary constructed vibrating rails.

3. The vibrating screen apparatus as given in claim 2 wherein ends of said shoes match said angle of said opposing clips.

4. The vibrating screen apparatus as given in claim 1 further comprising multiple stacked vibrating screen apparatus, each lower vibrating screen being finer in weave than upper vibrating screens.

5. The vibrating screen apparatus as given in claim 4 wherein of said multiple stacked vibrating screen apparatus each vibrating screen apparatus being pivotable with respect to lower vibrating screen apparatus.

6. The vibrating screen apparatus of claim 5 further comprising a hinge on and end of said frame for said pivotable motion.

7. The vibrating screen apparatus of claim 5 further comprising a hinge on a side of said frame for said pivotable motion.

8. A method of operation of a vibrating screen for separation of materials into different sizes including tensioning a vibrating screen between opposing walls of said vibrating device, inflating air mount isolators below vibrating rails to form a crown in said vibrating screen, setting said vibrating device at an incline, causing said vibrating screen to vibrate, feeding said materials onto an upper end of said vibrating screen, collecting said material less than a predetermined size that flows through said vibrating screen, and discharging said material greater than a predetermined size out a discharge end, the improvement includes:
mounting shoes on top of said air mount isolators; and
locating said shoes within clips of said vibrating rails in an abutting relationship.

9. The method as recited in claim 8 wherein an angle of said clips with respect to the longitudinal axis of said vibrating rails is greater than said incline.

10. The method as recited in claim 9 wherein ends of said shoes match said clips.

11. The method is recited in claim 8 includes stacking vibrating screens of different size mesh, courser mesh being on top and each successive lower vibrating screen being of a finer mesh.

12. The method as given in claim 11 further including pivots for pivoting an upper of said vibrating device to allow access to a lower of said vibrating device.

13. The method as given in claim 12 wherein said pivoting is on an end.

14. The method as given in claim 12 wherein said pivoting is on a side.
